(19) United States
(12) Patent Application Publication
(10) Pub. No.: US 2005/0149293 A1
(43) Pub. Date: Jul. 7, 2005

(54) Automatically notifying system for testing cellular phone module and method thereof

(75) Inventors: Chin-Wei Chang, Taipei (TW); Yao-Nan Chang, Taipei (TW); Zheng-Hui Liu, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Arima Communication Corp., Taipei (TW)

(21) Appl. No.: 10/752,636

(22) Filed: Jan. 6, 2004

(51) Int. Cl. G06F 11/30

(52) U.S. Cl. 702/185

(57) ABSTRACT

An automatically notifying system for testing a cellular phone module is provided. The system includes a control computer having a testing program for providing a test request, a testing device electrically connected with the control computer and the cellular phone module for testing the cellular phone module in response to the test request, and sending a test status back to the control computer, such that the testing program generates a trigger signal in response to the test status, and a control module electrically connected with the control computer for sending a warning message to a communication group in response to the trigger signal.

### FIELD OF THE INVENTION

This invention relates to a notifying system for testing a cellular phone module, and more particularly to an automatically notifying system for testing a cellular phone module and a method thereof.

### BACKGROUND OF THE INVENTION

In the process of designing the cellular phone, it is necessary to test all the functions of the developing products to ensure them meeting the relevant laws and regulations. Please refer to FIG. 1, which shows a schematic diagram of an automatically testing system for cellular phone functions testing system according to the prior art. The testing system includes the control computer 11, the testing device 13 and the cellular phone module 15. The control computer 11 has a testing program inside, and generally, is connected with the testing device 13 via the general purpose interface bus (GPIB) cable 12. Ordinarily, the testing device 13 is an Agilent wireless communication tester 8960 or a R&S wireless communication tester CMU200. A radio-frequency output/input terminal of the testing device 13 is connected with an antenna terminal of the cellular phone module 15 via a radio-frequency cable 14. The measurement of the testing system is described as follows:

Firstly, the cellular phone module 15 shall be confirmed to be turned on and its signals are synchronized with those of the testing device 13. Then, a test request is sent from the testing program inside the control computer 11 to the testing device 13. The testing device 13 will test the cellular phone module 15 when receiving the test request, and will send a test result back to the control computer 11 after the test is complete. Finally, the test result is displayed on the screen of the control computer 11 and stored in a data file for the user to confirm.

However, there are some disadvantages of employing the above-mentioned testing system to test the functions of the cellular phone module 15. For instance, it will take a lot of time to test the cellular phone module 15 if the test items include some time-consuming items (e.g. Sensitivity test), or if it is necessary to test full power and full channel, which cover different testing voltages and different testing temperatures. The purpose of the automatic testing system should be to save manpower, so that the user can be engaged in other relevant research and development jobs for the duration of the test. Nevertheless, in the duration of the test, the user wouldn't know whether the testing device 13 or the cellular phone module 15 is at an abnormal status or the test is complete, unless he checks by himself. Thus, it results in the inconvenience for the user and the waste of time. Furthermore, it is not efficient for the user to make the correct countermeasure immediately, and the testing device 13 can not be employed more effectively.

From the above description, it is known that how to develop a new notifying system and method with the advantages of saving manpower has become a major problem waited to be solved. In order to overcome the drawbacks in the prior art, an automatically notifying system and the notifying method thereof are provided. The particular design in the present invention not only solves the problem described above, but also saves a lot of testing time. Moreover, the notifying system has a simple structure and is easy to employ. Thus, the invention has the utility for the industry.

### SUMMARY OF THE INVENTION

It is an object of the present invention to provide a system having a simple structure and easy to employ. By utilizing the system and method of the present invention, the user can be notified via short messages when an abnormal status occurs during the process of the test and thereby make the correct countermeasure immediately. On the other hand, the user can also be notified via short messages when the test is complete, so that the test device can be more effectively employed by the user.

In accordance with one aspect of the present invention, an automatically notifying system for testing a cellular phone module includes a control computer having a testing program for providing a test request, a testing device electrically connected with the control computer and the cellular phone module for testing the cellular phone module in response to the test request, and sending a test status back to the control computer, such that the testing program generates a trigger signal in response to the test status, and a control module electrically connected with the control computer for sending a warning message to a communication group in response to the trigger signal.

Preferably, the testing program is written in Labview program language.

Preferably, a type of said warning message is set via said testing program by a user.

Preferably, the type of the warning message is one selected from a group consisting of a character message, an audio message, a video message and a graphic message.

Preferably, the testing device is a wireless communication tester.

Preferably, the test status is one of a test complete status and a test abnormal status.

Preferably, the control module is a hardware module having a functionality of sending short messages.

Preferably, the control module has a controlling program for driving the control module to send the warning message to the communication group in response to the trigger signal.

Preferably, the control module is connected with said control computer via a RS232 cable.

Preferably, the warning message is a short message.

Preferably, the communication group is a cellular phone group.

Preferably, the cellular phone group includes at least one cellular phone number.

In accordance with another aspect of the present invention, a method for an automatic notification in testing a cellular phone module via a control module and a control computer includes steps of: testing the cellular phone module for obtaining a test status and sending the test status back to the control computer, generating a trigger signal in response to the test status and sending the trigger signal from the control computer to the control module, and generating a warning message in response to the trigger signal and sending the warning message from the control module to a communication group.

Preferably, the control computer has a testing program for generating the trigger signal in response to the test status.

Preferably, the testing program is written in Labview program language.

Preferably, a type of the warning message is set via the testing program by a user.

Preferably, the type of said warning message is one selected from a group consisting of a character message, an audio message, a video message and a graphic message.

Preferably, the test status is one of a test complete status and test abnormal status.

Preferably, the control module is a hardware module having a functionality of sending short messages.

Preferably, the control module has a controlling program for driving the control module to send the warning message to the communication group in response to the trigger signal.

Preferably, the control module is connected with the control computer via a RS232 cable.

Preferably, the warning message is a short message.

Preferably, the communication group is a cellular phone group.

Preferably, the cellular phone group includes at least one cellular phone number.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing an automatic testing system for a cellular phone module according to the prior art; and

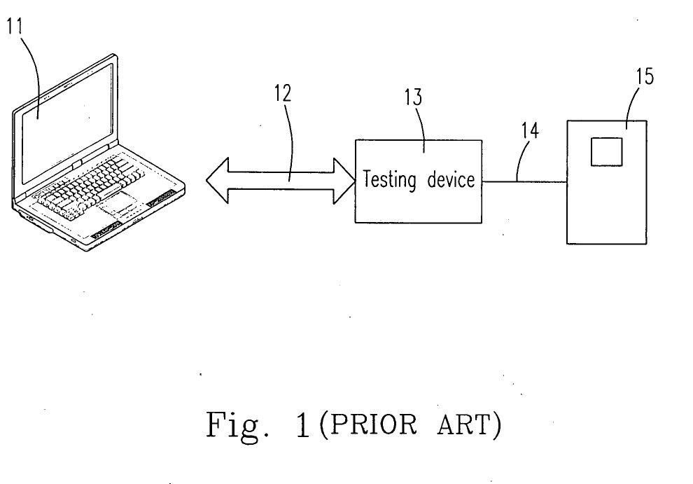

FIG. 2 is a schematic diagram showing an automatically notifying system for testing a cellular phone module according to a preferred embodiment of the present invention.

### DETAILED DESCRIPTION OF THE PREFERRED EMBODIMENT

The present invention will now be described more specifically with reference to the following embodiments. Presently, an automatically testing program written in Labview program language for controlling an Agilent wireless communication tester 8960 and a R&S wireless communication tester CMU200 has been developed in the industry. The automatically testing program is used for testing all the functions of the developing products, such as the global standard for mobile communication (GSM), digital communication system (DCS) and personal communication service (PCS), and etc. For achieving the purpose of notifying the test status forthwith, the present invention provides an automatically notifying system to notify the user of the test status via sending short messages. Thus, the automatically testing system can be performed with a maximum efficiency.

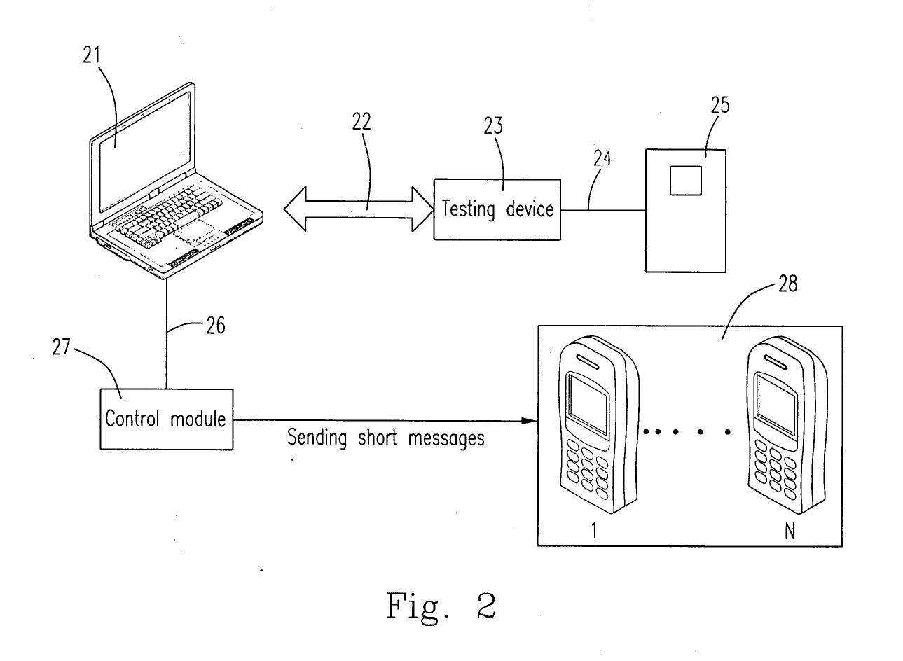

Please refer to FIG. 2, which shows a schematic diagram of an automatically notifying system for testing a cellular phone module according to a preferred embodiment of the present invention. The automatically notifying system includes the control computer 21, the testing device 23 (Agilent 8960 or R&S CMU200), the cellular phone module 25 and the control module 27. The control computer 21 has a testing program written in Labview program language, and is connected with the testing device 23 via a general purpose interface bus 22. A radio-frequency output/input terminal of the testing device 23 is connected with an antenna terminal of the cellular phone module 25 via the radio-frequency cable 24. The control module 27 is connected with the control computer 21 via the RS232 cable 26. The measurement of the notifying system is described as follows:

Firstly, the cellular phone module 25 shall be confirmed to be turned on and its signals are synchronized with those of the testing device 23. Then, a test request is sent from the testing program inside the control computer 21 to the testing device 23. The testing device 23 will test the cellular phone module 25 when receiving the test request, and will send a test status (a test complete status or a test abnormal status) back to the control computer 21. Next, the testing program will generate a trigger signal in response to the test status and then send it to the control module 27. Finally, a corresponding warning message is sent from the control module 27 to the cellular phone group 28, which is set by the user through the controlling program inside the control module 27. Certainly, the cellular phone group 28 includes one or more cellular phone numbers.

Preferably, the type of the warning message for being sent to the cellular phone group 28 can be set by the user via the testing program. For examples, the type of the warning message can be a character message, a audio message, a video message or a graphic message. Consequently, the warning message can be sent from the control module 27 to the cellular phone group 28 through the way of short messages, voice mails or graphic displays. Preferably, the control module 27 is a hardware module having the function of sending short messages.

In view of the aforesaid, the system of the present invention has a simple structure and is easy to employ. By utilizing the system and method of the present invention, the user can be notified via short messages when an abnormal status occurs during the process of the test and thereby make the correct countermeasure immediately. On the other hand, the user can also be notified via short messages when the test is complete, so that the testing device can be more effectively employed by the user. Accordingly, the present invention can effectively solve the problems and drawbacks in the prior arts, and thus fits the demand of the industry and is industrially valuable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An automatically notifying system for testing a cellular phone module, comprising:
a control computer having a testing program for providing a test request;
a testing device electrically connected with said control computer and said cellular phone module for testing said cellular phone module in response to said test request, and sending a test status back to said control computer, such that said testing program generates a trigger signal in response to said test status; and
a control module electrically connected with said control computer for sending a warning message to a communication group in response to said trigger signal.

2. The automatically notifying system as claimed in claim 1, wherein said testing program is written in Labview program language.

3. The automatically notifying system as claimed in claim 1, wherein a type of said warning message is set via said testing program by a user.

4. The automatically notifying system as claimed in claim 3, wherein said type of said warning message is one selected from a group consisting of a character message, an audio message, a video message and a graphic message.

5. The automatically notifying system as claimed in claim 1, wherein said testing device is a wireless communication tester.

6. The automatically notifying system as claimed in claim 1, wherein said test status is one of a test complete status and a test abnormal status.

7. The automatically notifying system as claimed in claim 1, wherein said control module is a hardware module having a functionality of sending short messages.

8. The automatically notifying system as claimed in claim 1, wherein said control module has a controlling program for driving said control module to send said warning message to said communication group in response to said trigger signal.

9. The automatically notifying system as claimed in claim 1, wherein said control module is connected with said control computer via a RS232 cable.

10. The automatically notifying system as claimed in claim 1, wherein said warning message is a short message.

11. The automatically notifying system as claimed in claim 1, wherein said communication group is a cellular phone group.

12. The automatically notifying system as claimed in claim 11, wherein said cellular phone group comprises at least one cellular phone number.

13. A method for an automatic notification in testing a cellular phone module via a control module and a control computer, comprising steps of:
testing said cellular phone module for obtaining a test status and sending said test status back to said control computer;
generating a trigger signal in response to said test status and sending said trigger signal from said control computer to said control module; and
generating a warning message in response to said trigger signal and sending said warning message from said control module to a communication group.

14. The method as claimed in claim 13, wherein said control computer has a testing program for generating said trigger signal in response to said test status.

15. The method as claimed in claim 14, wherein said testing program is written in Labview program language.

16. The method as claimed in claim 13, wherein a type of said warning message is set via said testing program by a user.

17. The method as claimed in claim 16, wherein said type of said warning message is one selected from a group consisting of a character message, an audio message, a video message and a graphic message.

18. The method as claimed in claim 13, wherein said test status is one of a test complete status and test abnormal status.

19. The method as claimed in claim 13, wherein said control module is a hardware module having a functionality of sending short messages.

20. The method as claimed in claim 13, wherein said control module has a controlling program for driving said control module to send said warning message to said communication group in response to said trigger signal.

21. The method as claimed in claim 13, wherein said control module is connected with said control computer via a RS232 cable.

22. The method as claimed in claim 13, wherein said warning message is a short message.

23. The method as claimed in claim 13, wherein said communication group is a cellular phone group.

24. The method as claimed in claim 23, wherein said cellular phone group comprises at least one cellular phone number.
